(19) United States
(12) Patent Application Publication
(10) Pub. No.: US 2003/0211217 A1
(43) Pub. Date: Nov. 13, 2003

(54) Product and process for delivering flavoring agents to food products

(76) Inventors: Franco Milani, Green Bay, WI (US); Susan Frinak, Green Bay, WI (US); Donna Klockeman, Depere, WI (US)

Correspondence Address: MICHAEL P. MAZZA, LLC, 686 CRESCENT BLVD., GLEN ELYN, IL, 60137, US

(21) Appl. No.: 10/140,772

(22) Filed: May 7, 2002

(51) Int. Cl. A23L 1/05

(52) U.S. Cl. 426/576

(57) ABSTRACT

An edible, manipulable carrier for delivering a predetermined amount of a flavoring agent to a food product, and a process for making the carrier. The flavoring agent is preferably substantially intermixed within the carrier, which rapidly melts upon contact with a heated food product.

### BACKGROUND OF THE INVENTION

The invention generally relates to a product and process for providing food products with spices and/or seasonings in dosed or pre-measured portions. More specifically, the invention relates to the provision of a relatively rapid-melting, edible carrier intermixed with the spices and/or seasonings (“flavoring agent”), and a continuous process for providing the edible carrier.

It is desirable to provide individual portions of an edible manipulable carrier for delivering dosed or pre-measured portions of a flavoring agent to various food products. Such carriers would preferably undergo a sharp transition to a fluid state (e.g., so that a flavor portion may rapidly melt on a hot hamburger prior to serving at a restaurant), and would preferably be manufactured by a continuous manufacturing process suitable for packaging and mass distribution.

Similar products are currently marketed in individual use containers (e.g., cups, shallow tubs, flexible pouches, etc.), but these represent higher packaging costs. The use of single serving packages in food service applications is also not advantageous. Therefore, it would be advantageous to provide a flavoring agents as described above using a continuous manufacturing process consisting of continuous extrusion, molding by continuous quiescent gel formation, portion reduction and assembly of multiple serving packages. The carrier is also preferably thermally reversible so that following gelation, it may be melted onto the food product. The melting profile for the carrier is also preferably chosen to optimize its use.

Prior art solutions suffer from other disadvantages. In the fast-food industry, for example, unskilled labor is often required to apply spices or seasonings to food products, resulting in over- or under-dosing and waste and/or flavor concerns. Some prior art solutions suffer from the failure to provide a carrier with a sharp transition to a meltable state (e.g., U.S. Pat. No. 5,063,073 to Kratochvil). Others fail to intermix the flavoring agent throughout the carrier, and provide for continuous manufacture of multiple portion packages (e.g., U.S. Pat. No. 5,858,426 to Bienvenu). Still others fail to disclose the use of suitable continuous processes conducive to mass production (e.g., EPO Patent Nos. 029856B1, 0237120B1, 0574973B1, and “The Joy Of Cooking” publication).

Accordingly, objects of the present invention include: the provision of a product consisting of individual portions of an edible, manipulable carrier for delivering dosed or pre-measured portions of an intermixed flavoring agent to food products. Preferably, the carrier is thermally reversible, and has a melting profile that undergoes a sharp transition to a fluid state. The carrier would also preferably eliminate the need for separate or costly measuring devices or pumps, as well as the need for unskilled labor to attempt to apply unmeasured portions of spices or seasonings to food products. A continuous process for manufacturing the carrier with flavoring agent would also preferably be provided which is suitable for rapid and convenient packaging and mass distribution.

### Definition of Claim Terms

The following terms are used in the claims of the patent as filed and are intended to have their broadest meaning consistent with the requirements of law. Where alternative meanings are possible, the broadest meaning is intended. All words used in the claims are intended to be used in the normal, customary usage of grammar and the English language.

“Activate” means to distribute dry ingredients in a liquid carrier such as water or other liquids, with the end result of the ingredient becoming functional as typically understood in food applications.

“Carrier” means a substance or combination of substances intermixed with a flavoring agent and in a form suitable for delivering the flavoring agent to a food product

“Flavoring agent” means any spices and/or seasonings useable or intended to be used for delivering flavor to a food product.

“Manipulable” means that the flavoring agent portion may be handled, either manually or by machine or automatic means, to provide the portion on a food product.

“Melt” means a noticeably visual phase transition from a gel to fluid state, though a complete transition to a fluid state need not occur for a food product to have “melted”.

“Melting profile” is the continuous rheological and viscometric measurement throughout the temperature range desired.

“Thermally reversible” means that following initial gel formation, the gel is meltable upon heating and, conversely, subsequent cooling results in re-annealing of the gel.

### SUMMARY OF THE INVENTION

The objects mentioned above, as well as other objects, are solved by the present invention, which overcomes disadvantages of prior art food products having spices and/or seasonings and processes for providing such food products, while providing new advantages not believed associated with such food products and processes.

In one preferred embodiment of the invention, an edible, manipulable carrier is provided for delivering a predetermined amount of a flavoring agent to a food product. Preferably, the carrier is thermally reversible. The carrier may include a carrier base of gelatin, a modified food starch and water. A flavoring agent is provided, and substantially intermixed, or homogeneously mixed, within the carrier base. Preferably, the carrier exhibits a melting profile such that the carrier rapidly melts upon contact with a heated food product to be flavored. For example, the carrier may melt within one minute when placed in an over-wrapped food product at a temperature of about 145° F. or above.

Other carrier components may be used, such as gelatin, preferably in the range of 150-300 Bloom. In one preferred embodiment, the carrier base includes, by weight, about 5-9% gelatin and about 12-18% modified food starch. In another embodiment, the carrier includes, by weight, about 8-15% seasoning, about 0-11% fat, and about 0-2% emulsifiers and/or preservatives. The carrier may also include Mira Clear® 340, and an emulsifier such as JOHA® C New.

In a preferred embodiment, the apparent viscosity of the carrier ranges from about 700-800 centipoise when its temperature is between about 90°-95° F. In this embodiment, the torque of the carrier decreases by more than about 100% when the carrier contacts a heated food product to be flavored and the temperature of the carrier increases from about 80° F. to about 90° F. Further, about 10 grams of the carrier, at a thickness of about 3/16 inches or less, undergoes a substantially complete transition from gel to fluid state in less than two minutes when placed on a heated surface having a temperature greater than about 105° F. As another example, with this embodiment, about 10 grams of the carrier undergoes a substantially complete transition from gel to fluid state in less than about 80 seconds when placed on a heated surface having a temperature greater than about 130° F.

A process for making an edible carrier for delivering a predetermined amount of a flavoring agent to a food product is also disclosed and claimed. Ingredients forming a carrier base suitable for delivering the carrier to a heated food product are mixed. A flavoring agent is substantially homogenously mixed within the carrier base. The carrier may then be extruded into a sheet, and the sheet may then be cut to form predetermined portions of the carrier suitable for delivery to a food product.

A predetermined portion of the carrier so processed, or processed in another manner, may then be applied to a heated food product to be flavored. The carrier preferably exhibits a melting profile such that the carrier rapidly melts upon contact with the heated food product. When melted on a heated food product, the carrier preferably has a thickness of about 3/16 of an inch or less. Preferably, the carrier melts on the heated product within about one minute when placed in an over-wrapped food product at a temperature greater than about 145° F. Also preferably, the apparent viscosity of the carrier ranges from about 700-800 centipoise when its temperature is between about 90°-95° F.

Predetermined portions of the carrier may be stacked within a multi-portion package, yet the portions may be easily separable from each other. To facilitate this easy separability, an anti-sticking agent, such as lecithin, may be added to the surface of the predetermined portions prior to their stacking.

### BRIEF DESCRIPTION OF THE DRAWINGS

The novel features which are characteristic of the invention are set forth in the appended claims. The invention itself, however, together with further objects and attendant advantages thereof, will be best understood by reference to the following description taken in connection with the accompanying drawings, in which:

FIG. 1 are schematic views of a carrier of the present invention undergoing melting on a food product (a hamburger);

FIG. 2 are schematic views of the carrier melting on a heated surface;

FIG. 3 is a graphical representation of Torque and Apparent Viscosity versus Temperature as measured for the Sweet Cayenne Pepper sample formulation described below; and

FIG. 4 is a graphical representation of the melting rate of a flavoring agent portion in a food application, described below.

### DETAILED DESCRIPTION OF THE PREFERRED EMBODIMENTS

Set forth below is a description of what are currently believed to be the preferred embodiments and/or best examples of the invention claimed. Future and present alternatives and modifications to these preferred embodiments are contemplated. Any alternatives or modifications which make insubstantial changes in function, in purpose, in structure or in result are intended to be covered by the claims of this patent.

In a preferred embodiment, a useful carrier according to the present invention is a gelatin-based matrix which acts as a rapidly melting delivery system for flavoring agents when placed in contact with hot or warm food items, such as but not limited to vegetables, side-dishes, sandwiches and portions of meat, etc. This delivery system provides for easy and consistent delivery of flavor variety to foods.

In the preferred embodiment, formation of a preferred carrier is accomplished by combining gelatin with modified food starch, dairy powders, emulsifying salts, seasonings and preservatives. Water is then added and the constituents are mixed until homogenous. Preferably, moderate shear and heat is provided to the mixture using a stainless steel heating vessel with a rotating auger. Time, temperature and shear rate combinations are selected to ensure solubilization and activation of the ingredients, in a manner generally well known to those of ordinary skill in the art.

Further processing may be accomplished using technology which is the subject of a separate co-pending patent application filed on the same day as the present application, assigned to the same assignee, and titled “Casting Apparatus And Process,” which is incorporated herein by reference. In summary, in a preferred embodiment the product may be pumped to an extrusion head and dispersed evenly along an endless cooling belt to form a uniform gelled sheet. The large sheet may be removed from the cooling belt, trimmed to a desired width, and slit into a series of elastic ribbons that are combined in a continuous stack. Anti-sticking agents, such as lecithin, may be applied at this point to aid in portion separation at end use. The stack may then be cut to length and cross-cut to form of series of individual stacks of product that are linearly aligned. These stacks may then be over-wrapped and packaged.

Each stack contains multiple servings. The stacks may consist of individual slices of the carrier/flavoring agent combination, with each slice consisting of an individual portion of concentrated flavoring agent. Alternatively, the stacks may be coherent, likes pats of butter, which may be notched or otherwise dosable into individual portions.

A particularly preferred embodiment of the present invention will now be described. All percentages are weight percentages. A useful carrier has been found to consist of about 0-15% seasoning, and more preferably about 8-15% seasoning; about 5-9% gelatin; about 0-18% and more preferably about 12-18% carbohydrate (e.g., starch, modified food starch, maltodextrin, corn syrup solids, sugars and polysaccharide; about 0-11% fat; and water or another suitable liquid carrier, as needed. Emulsifiers and/or preservatives may also be used in the range of about 0-2%.

One specific carrier according to the present invention for providing the flavor of sweet cayenne pepper consists of the following ingredients: seasoning (11.8%); gelatin (7%); Mira Clear® 340 (3.75%); corn syrup solids (11.40%); fat (9%); sodium hexametaphosphate (0.40%); JOHA® CNew (0.70%); sorbic acid (0.20%); dairy powder (0.25%); and water (as needed).

Another specific carrier for providing the flavor of cracked black pepper with garlic consists of the following ingredients: seasoning (10.0%); gelatin (7.25%); Mira Clear 340 (3.75%); corn syrup solids (11.40%); fat (9%); sodium hexametaphosphate (0.40%); JOHA® C New (0.70%); sorbic acid (0.20%); dairy powder (0.25%); and water (as needed).

For these applications, a preferred gelatin is in the range of about 150-300 Bloom, and most preferably about 250 Bloom.

Mira Clear® 340 is a modified food starch manufactured by A. E. Staley of Manufacturing Company, 2200 E. Eldorado Street, Decatur, Ill.

JOHA® C New is a phosphate-based emulsifying salt for processed cheese manufactured by B K Landenburg Corporation of 2345 Erringer Road, Simi Valley, Calif. Preferably, the pH of the carrier formulation is controlled to be within the range of 4.5-5.5. One way to accomplish this is to use an emulsification system, such as varying amounts of JOHA® C New emulsifier to obtain the desired pH level.

The above-mentioned carriers may be formulated with two components that contribute predominantly to hot and cold product texture and fluid viscosity: modified food starch (Mira-Cleer® 340) and gelatin (250 Bloom). Other components also known to bind water (i.e., corn syrup solids and dairy powder), contribute to product texture and viscosity, but in a lesser sense. At temperatures below about 70° F., the products exhibit a primary viscosity resulting from both the annealed gelatin and modified food starch components.

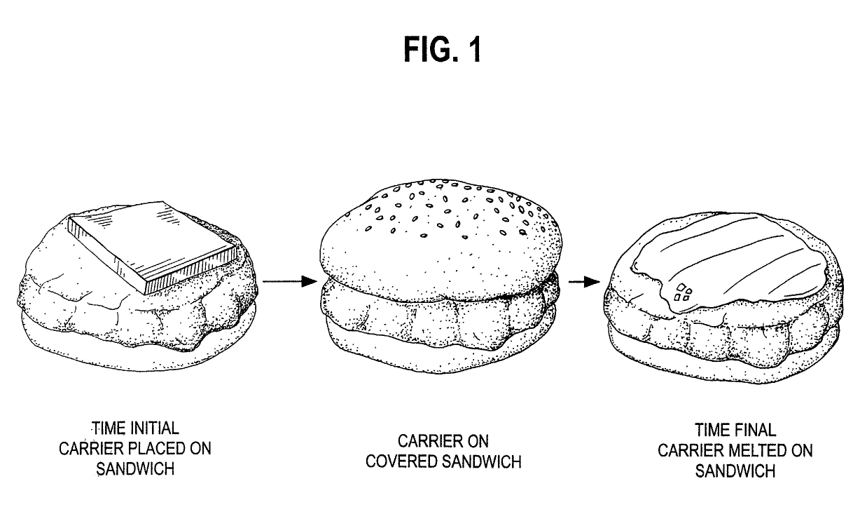

A preferred carrier of the present invention rapidly melts when placed in contact with a heated food product. For example, referring to FIG. 1, a carrier made as disclosed here has been found to melt within one minute when placed in an over-wrapped food product at a temperature of about 145° F. or above.

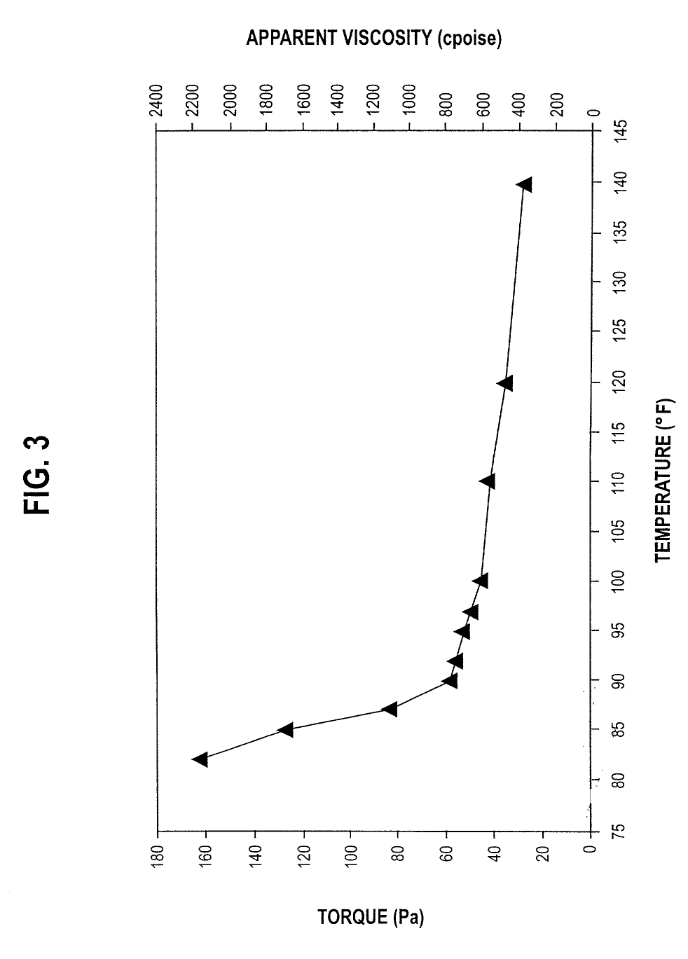

As can be seen in FIG. 3, as the temperature approaches the melting point of the gelatin, the measured viscosity rapidly decreases (−179 Centipoise per degree Fahrenheit). Once the gelatin component is melted, there is a secondary viscosity that exhibits a slight linear decrease (−7.8 Centipoise per degree Fahrenheit, where R²=0.97) as the product temperature is increased from 95° F.-140° F. The modified starch and the de-annealed gelatin are predominantly responsible for the observed secondary viscosity above 95° F.

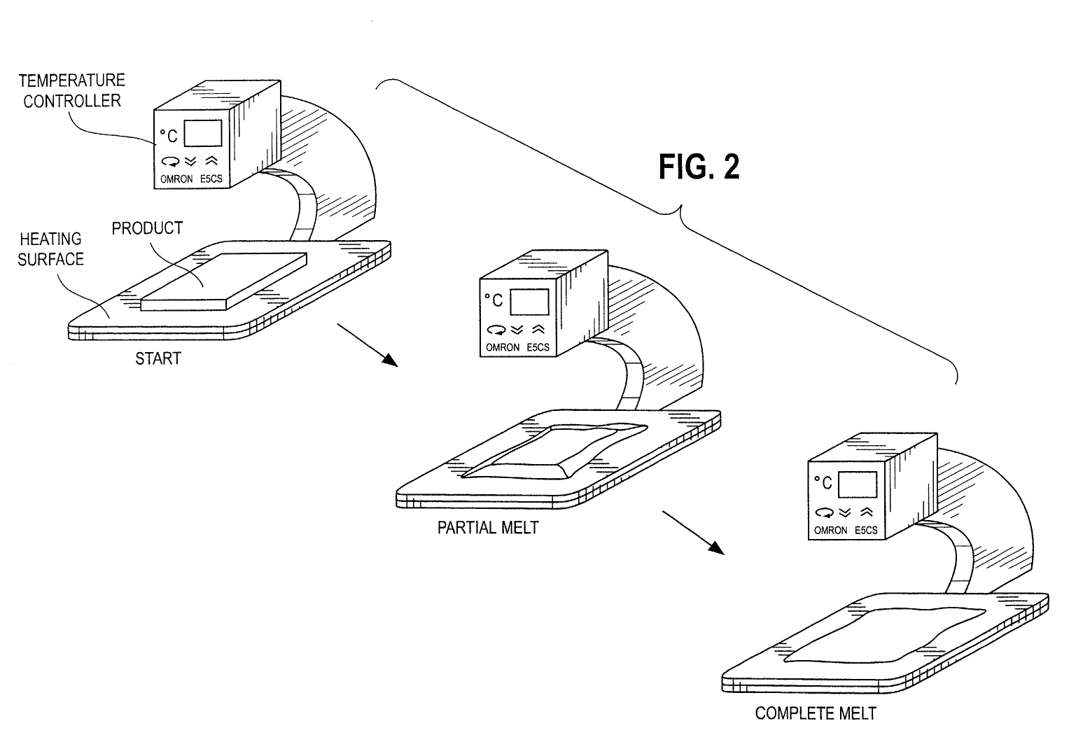

Still referring to FIG. 3, it can be seen that the apparent viscosity of the carrier ranges from about 700-800 centipoise when its temperature is between about 90°-95° F. In this embodiment, the torque of the carrier decreases by more than about 100% when the carrier contacts a heated food product to be flavored, as shown in FIG. 2, and the temperature of the carrier increases from about 80° F. to about 90° F. Further, about 10 grams of the carrier undergoes a substantially complete transition from gel to fluid state in less than two minutes when placed on a heated surface having a temperature greater than about 105° F. As another example, with this embodiment, about 10 grams of the carrier undergoes a substantially complete transition from gel to fluid state in less than about 80 seconds when placed on a heated surface having a temperature greater than about 130° F.

During manufacture of the carrier/flavoring agent product, the product is extruded at a temperature above 140° F. As the product travels along a continuous cooling belt, for example, the viscosity increases. This increase in viscosity results from both the gelatin and modified food starch components. Annealing of the gelatin and the subsequent starch gel formation allow for the continuous manufacture of the product. The solidified product maintains some elasticity which aids in the secondary mechanical manipulation of the extruded sheet and product stacks.

Referring again to FIG. 3, torque is a measure of rotational force that is proportional to apparent viscosity. It is the reading from the analytical instrument that is used to calculate the apparent viscosity based on other instrument control parameters. The data shown in FIG. 3 was collected with a rotational viscometer. Measured torque is represented on the primary y-axis. The calculated values for apparent viscosity are shown on the secondary y-axis and range from about 370-2100 centipoise. These values in the temperature range of 90° F.-95° F. are 700-770 centipoise, respectively.

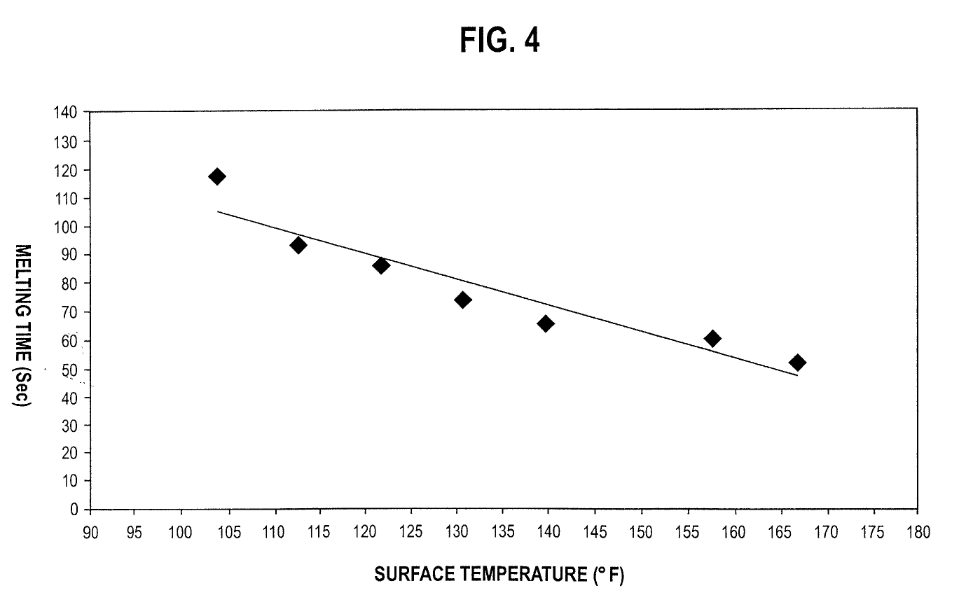

Carriers placed on a heated surface, as shown in FIG. 2, exhibited the graphed characteristics shown in FIG. 4. Referring to FIG. 4, the “y” axis shows the observed time required for complete transition from gel to fluid state of a 10.0 gram portion of Sweet Cayenne Pepper sample formulation at 59° F. (±2° C.) when placed on an open, heated surface having a variable temperature (±2° F.) as plotted on the “x” axis. FIG. 4 shows the linearly decreasing relationship between temperature and melting time (R²=0.95).

It will be understood that different processes may be used to make the carrier with flavoring agent described here, other than casting technology. Here are some examples: (1) filling the carrier into a rigid or thermoformed container of individual or multiple portion sizes (e.g., cups or shallow trays like sour cream, coffee creamer, or individual servings of butter/margarine); (2) filling the carrier into flat or thermoformed pouches/pockets (either like ketchup/mustard packets, “string cheese” or portable single serving yogurt); (3) the use of frames and cooling as disclosed in U.S. Pat. No. 2,799,589, incorporated herein by reference; (4) individually wrapped slice technology (e.g., processed cheese singles), as disclosed in U.S. Pat. No. 5,440,860, incorporated herein by reference; (5) forming the carrier into a large loaf/block and then later cutting it into shapes (e.g., slices, cubes or sticks) that could be incorporated into items such as: (a) filled/stuffed meat entree items (“Chicken Kiev”); (b) hand held pocket sandwiches (burritos, stromboli, calzones); (c) wrapped filled items (egg rolls, ravioli, tortellini, dumplings,); (6) marking out the carrier product or depositing it by serving size onto an interleaf backing sheet (e.g., parchment paper, flexible film or aluminum foil) or a continuous molding surface to form portions which can be stacked for multiple use packages; (7) as an alternative to the cheese-like stacking of the casted product, the carrier could be casted into ribbons of a set width, and the ribbons could be wound onto spools with or without interleaf backing material to provide flexible portion sizes for use in the preparation of larger multi-serving food service food items in addition to single portion items; or (8) casting the carrier into a continuous sheet directly onto the interleaf backing material and then winding it onto the spools.

The above description is not intended to limit the meaning of the words used in the following claims that define the invention. Rather, it is contemplated that future modifications in structure, function or result will exist that are not substantial changes and that all such insubstantial changes in what is claimed are intended to be covered by the claims.

We claim:

1. An edible, manipulable carrier for delivering a predetermined amount of a flavoring agent to a food product, comprising:
a carrier base comprising gelatin, a modified food starch and water;
a flavoring agent substantially intermixed within the carrier base;
wherein the carrier exhibits a melting profile such that the carrier rapidly melts upon contact with a heated food product to be flavored.

2. The edible carrier of claim 1, wherein the carrier melts on a heated product within about two minutes of contacting a surface of the food product having a surface temperature in excess of 100° F.

3. The edible carrier of claim 1, wherein the carrier is thermally reversible.

4. The edible carrier of claim 1, wherein the gelatin is in the range of 150-300 Bloom.

5. The edible carrier of claim 1, wherein the carrier base comprises, by weight, about 5-9% gelatin and about 0-18% modified food starch.

6. The edible carrier of claim 5, wherein the carrier further comprises, by weight, about 8-15% seasoning, about 12-18% food starch, about 0-11% fat, and about 0-2% emulsifiers and/or preservatives.

7. The edible carrier of claim 1, wherein the carrier further comprises Mira Clear® 340.

8. The edible carrier of claim 1, wherein the carrier further comprises JOHA® C New.

9. The edible carrier of claim 1, wherein the apparent viscosity of the carrier ranges from about 700-800 centipoise when its temperature is between about 90°-95° F.

10. The edible carrier of claim 1, wherein the torque of the carrier decreases by more than about 100% when the carrier contacts a heated food product to be flavored and the temperature of the carrier increases from about 80° F. to about 90° F.

11. The edible carrier of claim 1, wherein about 10 grams of the carrier undergoes a substantially complete transition from gel to fluid state in less than two minutes when placed on a heated surface having a temperature greater than about 105° F.

12. The edible carrier of claim 1, wherein about 10 grams of the carrier undergoes a substantially complete transition from gel to fluid state in less than about 80 seconds when placed on a heated surface having a temperature greater than about 130° F.

13. An edible, manipulable carrier for delivering a predetermined amount of a flavoring agent to a food product, comprising:
a carrier base suitable for delivering the carrier to a heated food product;
a flavoring agent substantially homogenously mixed within the carrier base;
wherein the torque of the carrier decreases by more than about 100% as its temperature increases from about 80° F. to about 90° F.

14. An edible, manipulable carrier for delivering a predetermined amount of a flavoring agent to a food product, comprising:
a carrier base suitable for delivering the carrier to a heated food product;
a flavoring agent substantially homogenously mixed within the carrier base;
wherein the apparent viscosity of the carrier changes by more than 100% as the temperature of the carrier increases from about 80° F. to about 90° F.

15. A process for making an edible carrier for delivering a predetermined amount of a flavoring agent to a food product, comprising the steps of:
mixing ingredients forming a carrier base suitable for delivering the carrier to a heated food product;
substantially homogenously mixing a flavoring agent with the carrier base;
casting the carrier into a sheet; and
cutting the sheet to form predetermined portions of the carrier suitable for delivery to a food product.

16. The process of claim 15, further comprising the step of applying a predetermined portion of the carrier to a heated food product to be flavored wherein the carrier exhibits a melting profile such that the carrier rapidly melts upon contact with the heated food product.

17. The process of claim 15, wherein the carrier melts on the heated product within two minutes of contacting a surface of the food product having a surface temperature in excess of 100° F.

18. The process of claim 15, wherein the apparent viscosity of the carrier ranges from about 700-800 centipoise when its temperature is between about 90°-95° F.

19. The process of claim 15, wherein the torque of the carrier decreases by more than about 100% as the carrier contacts a heated food product to be flavored and the carrier temperature increases from about 80° F. to about 90° F.

20. The process of claim 15, wherein the predetermined portions are stacked within a multi-portion package yet easily separable from each other.

21. The process of claim 20, further comprising the step of adding an anti-sticking agent to a surface of the predetermined portions prior to stacking.

22. The process of claim 21, wherein the anti-sticking agent comprises lecithin.

23. The process of claim 15, wherein the carrier melt within about one minute when placed in an over-wrapped food product at a temperature of about 145° F. or above.
